(19) United States
(12) Patent Application Publication
(10) Pub. No.: US 2008/0274865 A1
(43) Pub. Date: Nov. 6, 2008

(54) Processing Plant

(76) Inventor: Thomas Sturm, Wiedenzhausen (DE)

Correspondence Address: MCGLEW & TUTTLE, PC, P.O. BOX 9227, SCARBOROUGH STATION, SCARBOROUGH, NY, 10510-9227, US

(21) Appl. No.: 12/067,212

(22) PCT Filed: Sep. 20, 2006
(86) PCT No.: PCT/EP2006/009130

§ 371 Date: Mar. 18, 2008

(30) Foreign Application Priority Data
Sep. 23, 2005 (DE) 20 2005 015 118.1

(51) Int. Cl. B23Q 7/00; B23Q 7/04

(52) U.S. Cl. 483/15; 29/564; 29/33 R; 483/3

(57) ABSTRACT

A machining or processing plant (1) is provided including one or several machining stations (2) that are surrounded by a protective partition (13) and are supplied with components (4, 5) from at least one external supply (6) by a feeding mechanism (8). The feeding mechanism (8) is provided with one or several distribution vehicles (9) which can be moved between the supply (6) and the processing stations (2). The distribution vehicles (9) are equipped with a multi-shaft manipulator (10) and a device (36) for surmounting the protective partitions (13). The distribution vehicles (9) are also equipped with one or several receptacles (30) for component supports (24, 25).

### CROSS REFERENCE TO RELATED APPLICATIONS

This application is a United States National Phase application of International Application PCT/EP2006/009130 and claims the benefit of priority under 35 U.S.C. § 119 of German Patent Application DE 20 2005 015 118.1 filed Sep. 23, 2005, the entire contents of which are incorporated herein by reference.

### FIELD OF THE INVENTION

The present invention pertains to a machining plant with at least one machining station with a protective enclosure surrounding same, with at least one readiness position and with a feeding means for feeding components.

### BACKGROUND OF THE INVENTION

Such a machining plant is known from practice. It contains one or more machining stations, which are surrounded by a protective enclosure, e.g., a fence, which prevents free access to the work area within the machining station for persons for safety reasons. One or more special accesses with special securing means, which switch off the machining devices arranged in the machining station, especially machining robots, in case of access, are present for the entry of persons. A plurality of components are joined to one another or optionally also to a workpiece fed from the outside in the machining station or machining stations. The components are made ready in one or more component magazines on the outside of the protective enclosure, where they are commissioned manually by workers and transferred to stationary feeding means, which transport the components through the protective enclosure into the interior space of the machining station and make them ready there for picking up and processing for the machining devices, especially robots. This conventional component logistics requires the use of a large amount of manpower, device and protection technology. In addition, there is a large space requirement on the outsides of the machining stations. In addition, the circumstance that the feeding means and the component magazines shall be designed ergonomically favorably is unfavorable. This leads in many cases in practice to unfavorable pick-up positions for the robots within the machining station. The feeding means have, furthermore, a disturbing effect on the accessibility of the machining stations.

### SUMMARY OF THE INVENTION

The object of the present invention is to improve the component logistics.

According to the invention, a processing or machining plant is provided comprising a machining station with a protective enclosure surrounding same, a readiness position and a feeding means for feeding components. The feeding means comprises at least one distributing vehicle movable between the readiness position and the machining station. The distributing vehicle have a multiaxial manipulator with a means for clearing the protective enclosure and with a support for component carriers.

The embodiment of the feeding means according to the present invention and of the component logistics has the advantage of substantially reducing the construction and work effort.

The distributing vehicles with their manipulators can replace at least part but preferably all hitherto common stationary component guides at the machining station or machining stations. The width of the station is considerably reduced. The space requirement for the entire machining plant decreases as a result. The outer contour of the machining station and of the protective enclosure can extend extensively linearly. On the whole, the plant and station concept as well as the logistics concept are substantially less expensive and more flexible than previous systems. The manual handling and commissioning activities can be shifted by the component logistics being claimed away from the machining station at least for the most part and to a component readiness position, especially a component center. On the whole, the manual handling operation and the staff needed herefor can be reduced as a result.

Another great advantage is the reduction of the safety effort needed for protecting the staff at the machining station. The manual handling and feeding tasks performed hitherto are taken over by the distributing vehicle and the manipulator. They have a means for clearing the protective enclosure, which replaces the previous construction and safety effort at the stationary feeding means. In the simplest case, the manipulator can perform its handling operations beyond the protective enclosure in case of a corresponding arrangement and embodiment. In another variant, the distributing vehicle and/or the manipulator may have an opening device in order to open and close an entry to the machine in the protective enclosure. Unauthorized persons cannot open this entry. The protective enclosure can retain its person protection function as a result, and, on the other hand, it can be substantially simplified. Person protection is also guaranteed with this mechanical component logistics. On the one hand, the distributing vehicle may have a preferably circumferential protective screen, which denies access to the vehicle areas located inside for persons. The manipulator can likewise grasp beyond this protective screen of its own for handling purposes and for loading and unloading. The work area of the manipulator can likewise be secured by an optionally controllable locking mechanism for person protection, so that the motions of the manipulator and the work are limited to areas to which persons have no access. Accesses to machines at the protective enclosure can also be covered and screened against access for persons with the distributing vehicle screened on the other side during the handling operation. Similar safety measures may also be made at the component readiness position, especially at a component center.

The mechanical component logistics makes it possible to feed and handle the components in component carriers, which can accommodate one or more components of the same or different type. This simplifies and reduces the handling effort and also the commissioning effort for loading the component carriers. This loading may be carried out in the above-mentioned sense outside the machining station at a preferably central site in a component center. The repeated reloading necessary with the state of the art can be eliminated. Commissioning may already take in the extreme case at the manufacturers of the components, so that already precommissioned components are available in the readiness position and the manual commissioning and loading effort can be reduced even further or even eliminated. The component logistics may take place partly or fully automatically. Moreover, it is possible by standardizing component carriers to reduce the handling and readiness effort in the entire machining plant, in which case a changeover to another type or another number of components is also readily possible.

The manipulator on the distributing vehicle may also have other tasks besides the handling of components or component carriers. It may perform, e.g., joining tasks during the transportation of the component and, e.g., assemble and optionally join different components into one group. The manipulator may now also perform machining operations, e.g., welding, bonding, screwing, coating or the like with corresponding tools. The manipulator may, moreover, also be used at the docking site at the machining station for handling and joining tasks within the machining station and in the processes taking place there.

The limitations dictated by ergonomics in the component feed are substantially reduced. Ergonomic conditions need to be taken into account essentially only at the composition readiness position, especially at the component center. The components can be made ready within the machining station in positions that are optimal for the machining devices located there, especially robots. In case of subsequent shifts of the work contents of individual stations, the effects or limitations in respect to component feed are substantially smaller than in the state of the art. It may happen that only new stops need to be introduced for the distributing vehicles. No workers are absolutely necessary any longer at the machining station proper, even if they may still be present for purposes of checking or for certain handling tasks.

Furthermore, the improvement of the accessibility of the machining stations and of the entire machining plant is favorable. The flexibility of the machining stations and of the machining plant is increased. Components can be introduced from any desired site. The simple possibility of using the distributing vehicles, which can service a plurality of machining stations or even a plurality of machining plants, is also favorable. Already existing machining stations or machining plants can be retrofitted or converted with the component logistics being claimed. The logistics is, moreover, adaptable and can continue to be used should the components or workpieces change.

It is advantageous, furthermore, that machining plants processing relatively smaller numbers of components can also be charged economically with components. The distributing vehicle can be used for maintenance, cleaning and inspection work during the production-free time. It can thus be used multifunctionally. The distributing vehicle or the manipulator located thereon can perform a tool change and take on tools suitable for these services, such as spray guns, grease guns, industrial vacuum units, etc. The distributing vehicle and/or the manipulator may have an optical monitoring system for controlling and checking the handling operations and also the aforementioned services, which may be designed, e.g., as a vision system.

The present invention is schematically shown in the drawings as an example. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic top view of a machining plant with a plurality of machining stations, a readiness position with a component center and with a component feeding means with a plurality of distributing vehicles;

FIG. 2 is a schematic enlarged top view of a machining station with a docked distributing vehicle;

FIG. 3 is a schematic side view of a distributing vehicle;

FIG. 4 is a schematic rear view of the distributing vehicle;

FIG. 5 is a schematic top view of the distributing vehicle;

FIG. 6 is a schematic top view of a distributing vehicle in the docked position at a machining station shown in a cut-away position;

FIG. 7 is a schematic front view of a distributing vehicle in the docked position at a machining station shown in a cut-away position;

FIG. 8 is a schematic top view of details of a distributing vehicle in a component center;

FIG. 9 is a schematic front view of details of a distributing vehicle in a component center;

FIG. 10 is a schematic top view showing a variant of a distributing vehicle in the docked position at a machining plant provided with bays as well as an alternative view of a distributing vehicle.

FIG. 11 is a schematic front view showing the variant of a distributing vehicle in the docked position at a machining plant provided with bays

### DESCRIPTION OF THE PREFERRED EMBODIMENTS

Referring to the drawings in particular, The present invention pertains to a component logistics for a machining plant 1) with the device and process technology belonging to it.

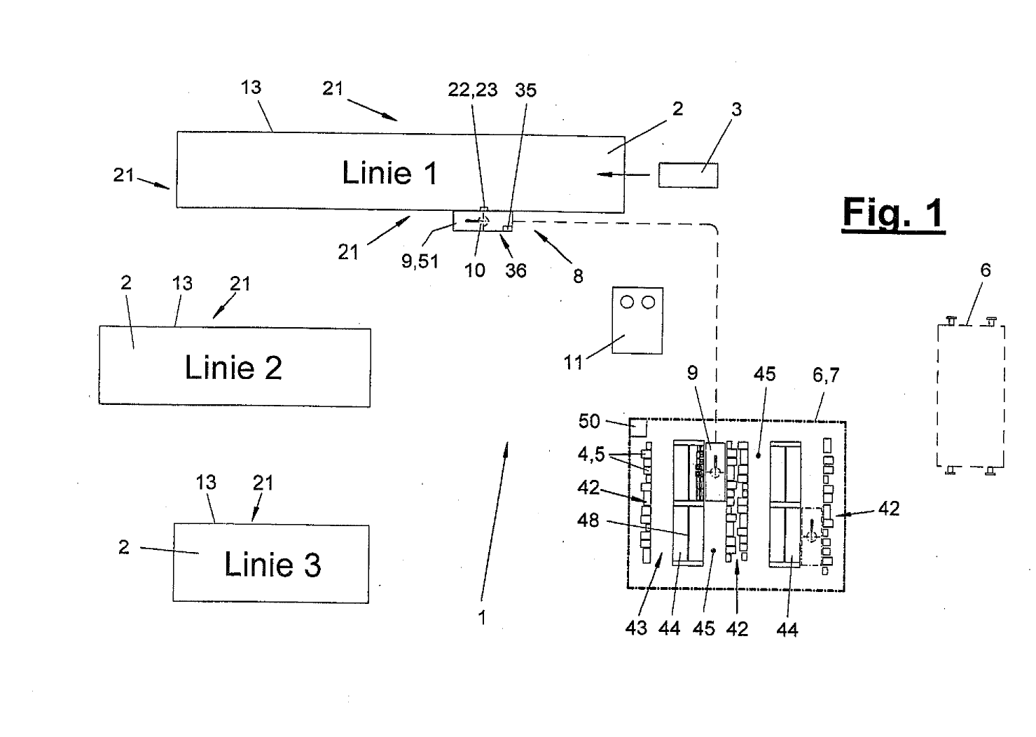

FIG. 1 shows a schematic top view of a machining plant 1, which has one or more machining stations 2, which are designated here as lines 1, 2 and 3. The machining plant 1 has, furthermore, at least one readiness position 6 for components 4, 5, which is designed, e.g., as a component center 7. As an alternative or in addition, another readiness position 6 may be present, which may be, e.g., a transport vehicle indicated by broken line, especially a railroad car, a truck or the like, in which components 4, 5 are brought precommissioned into the machining plant 1 or are made ready here. The readiness position 6 is located outside of and optionally separated in space from the machining stations 2. A readiness position 6 can service a plurality of machining stations 2.

The machining plant 1 contains, furthermore, a component feeding means 8, with which the components 4, 5 are transported from the external readiness position 6 to the individual machining stations 2 and are transferred there. The component feeding means 8 has one or more mobile distributing vehicles 9, which travel between the readiness position or readiness positions 6 and the machining plant or machining plants 2. One of the different possibilities of motion is shown in FIG. 1 in broken line as an exemplary variant.

Components 4, 5 of any desired type, size and number are machined and handled in the machining plant 1 and the machining stations 2. The components 4, 5 are joined to one another in the machining station 2. In addition, the components 4, 5 can be joined to one or more other workpieces 3, which reach the machining station 2 by another route, especially via a transfer line or a conveyor. The components 4, 5 and workpieces 3 are body parts of motor vehicles in the preferred embodiment. The components 4, 5 may be, e.g., parts of a side panel. The components 4, 5 may be, on the other hand, assembly parts, e.g., screws or other auxiliary means. Other variants are possible as well.

The machining stations 2 may have any desired design and be used to perform any desired machining or handling process. One or more machining and/or handling devices not shown may be arranged in the individual machining station 2. These may be, e.g., multiaxial industrial robots with corresponding tools. For example, handling and machining tasks are performed with these during the joining of the components 4, 5. The individual machining station 2 may have a station control (not shown). As an alternative or in addition, a higher-level plant control may be present.

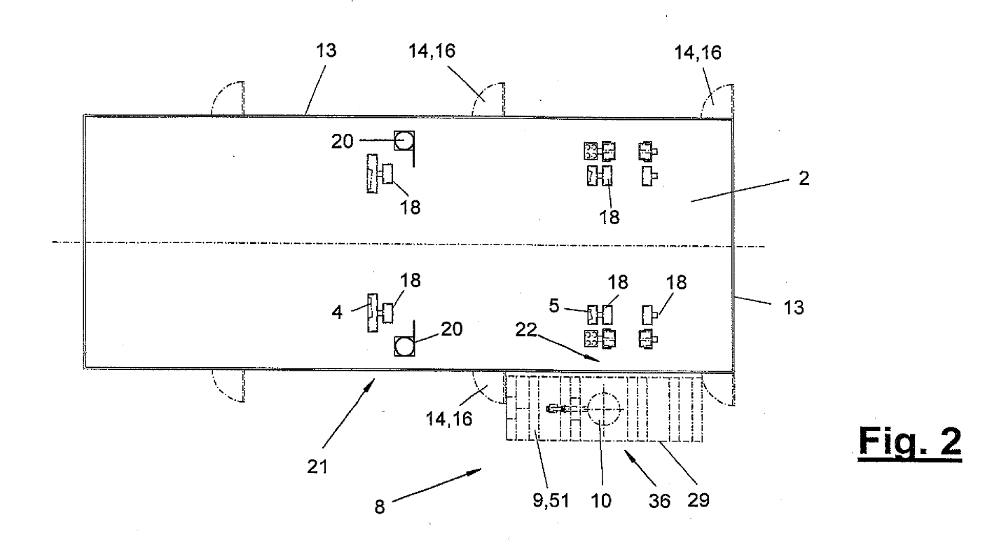

The machining station 2 is surrounded on the outside by a peripheral protective enclosure 13, which prevents access to unauthorized persons. The protective enclosure 13 is designed, e.g., as a fence with a height corresponding to that of a man. As an alternative, it may also be a fixed wall, e.g., at a laser welding box. As is illustrated in FIG. 2 and FIG. 10, the protective enclosure 13 may have one or more accesses 14, 15 with a safety means 16. These may be, e.g., accesses 14 for persons in the form of doors, which can be opened only when access without hazards is possible. For example, the safety means 16 switches off for this purpose the machining devices (not shown) located in the machining station. In a variant, the safety means 16 may trigger an emergency stop or emergency shutdown of the machining devices when the access 14 is opened.

The other accesses 15 may be accesses to the machine, which cannot be opened by unauthorized persons and which can be opened by the distributing device 10 in the manner described below. Furthermore, remote-controllable accesses not shown may be present for introducing and removing the workpieces 3. The machining stations 2 have, e.g., an elongated shape and a preferably central axis for the machining and joining progression as well as optionally for the transportation of the workpiece or workpieces 3.

A free traffic space 21 is present in at least some areas on the outside at the machining stations 2 to be loaded with components 4, 5 for the arrival, stopping and departure of at least one distributing vehicle 9. An area, which is kept free from attached structures, deposited objects or the like, is present for the unhindered travel of the distributing vehicle, e.g., peripherally on the outside at the protective enclosure 13 in the embodiment being shown. This may be, e.g., a free corridor.

One or more docking sites 22 for one or more distributing vehicles 9 may be present on one or more outsides of the machining station 2. The distributing vehicle 9 can assume at these docking sites 22 a predetermined, exact position, which is favorable or even necessary for carrying out the handling tasks accurately. Furthermore, an energy supply means 23 for the distributing vehicle 9 may be present at the docking site 22. The energy supplied may be electric current, a fluid fuel or the like. In addition, operating materials, e.g., cooling water, compressed air, hydraulic fluid or the like may be transferred at this site. Signal transmission is also possible. Furthermore, a stationary positioning aid for positioning the vehicle, which is equipped with corresponding mechanical support and guide means, may be present at the docking site 22. Such docking sites 22 may also be arranged in other locations in the machining plant 1, e.g., at the readiness position 6.

The components 4, 5 are preferably commissioned and transported on suitable component carriers 24, 25. The commissioning may take place at the component center 7 in the manner described below. As an alternative or in addition, precommissioned component carriers 24, 25 loaded with components 4, 5 may also be delivered to and kept ready at the readiness position 6. The distributing vehicles 9 shuttle between the machining stations 2 and the readiness position, feeding loaded component carriers 24, 25 and returning empty component carriers 24, 25. As an alternative, the components 4, 5 may also be transported and fed without component carriers 24, 25.

The component carriers 24, 25 may have any desired and suitable design. They may be, e.g., containers with side walls, pallets or any other carrying means, which optionally have suitable component supports and fixing means for the components 4, 5. The component carriers 24 have a shape and size appropriate for handling as well as a weight that is favorable for lifting. As an alternative or in addition, other component carriers 25 are possible for heavy load purposes, which may be designed, e.g., as roller pallets and are moved on the floor or in suitable suspended guides. They are suitable for especially heavy components 4, 5 or an especially large collection of components 4, 5.

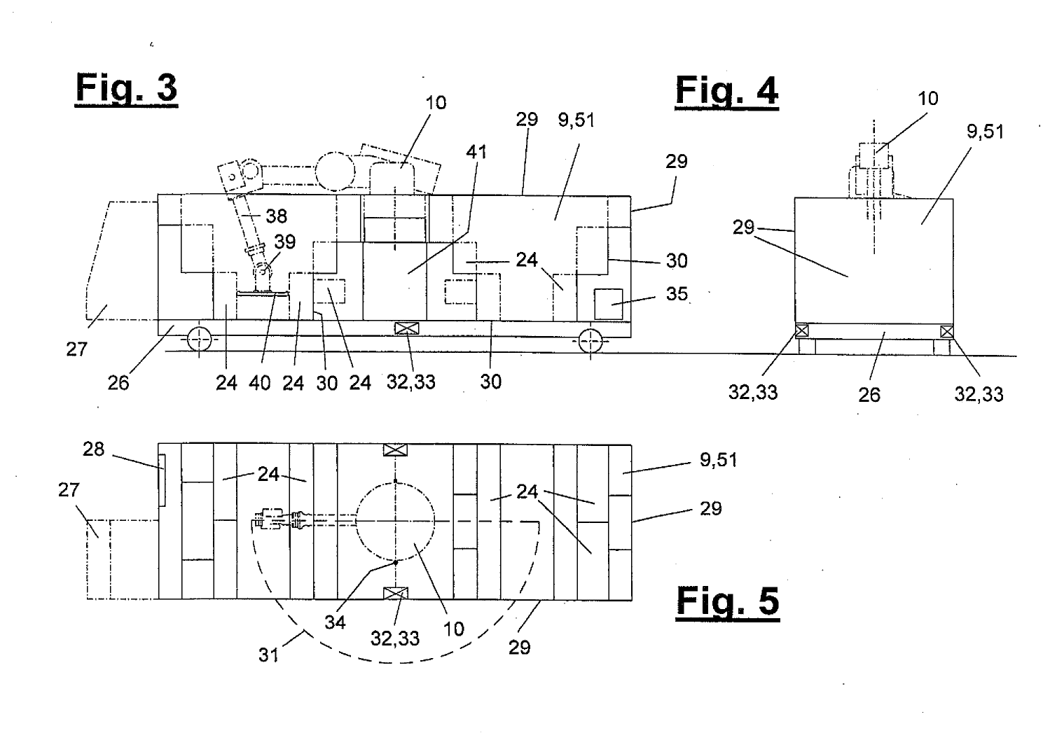

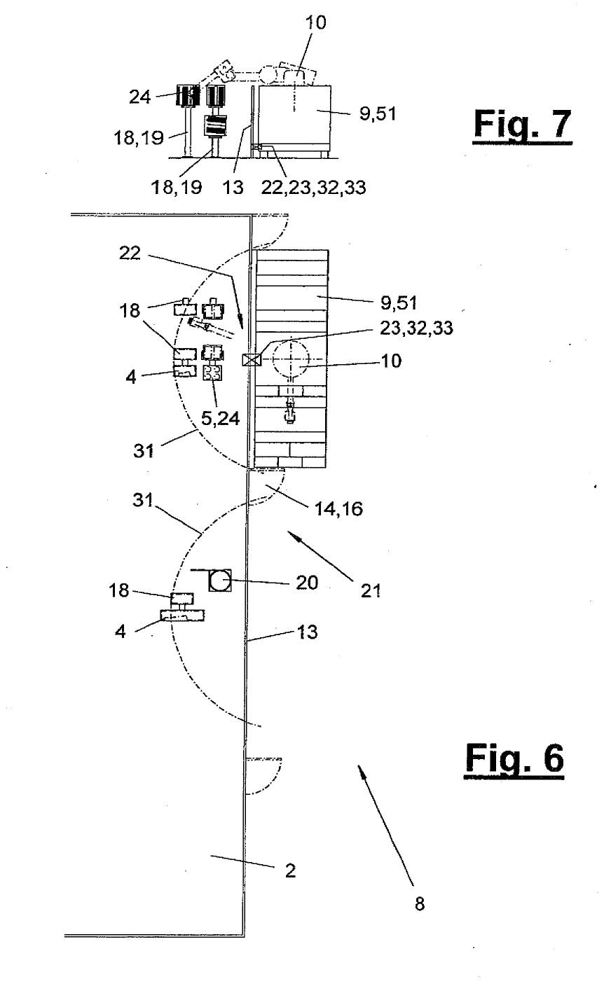

FIGS. 3 through 5 show a detail of a distributing vehicle 9. It has a chassis 26, with which it can roll on wheels on the floor of the plant or move along a guide erected on posts in the form of an overhead conveyor. The distributing vehicle 9 is preferably self-propelled and has a corresponding drive, e.g., an electric motor with transmission. The distributing vehicle 9 can be steered in any desired and suitable manner, e.g., by a front axle steering or front wheel steering, combined steering of the front and rear wheels or by an articulated frame steering of a correspondingly split chassis 26.

The distributing vehicle 9 may have an integrated energy supply, e.g., a battery. This may be recharged at a docking site 22 via the energy supply means 23 or at another site. As an alternative, permanent energy supply via a trailing cable, inductive transmission or the like is possible. Any other type of drives, energy source or energy storage means or energy supplies is possible in another variant.

The distributing vehicle 9 may have a driver stand 27 for manual operation. As an alternative, this may be eliminated for fully automatic operation. In addition, the distributing vehicle 9 has a safety sensor system 28, which detects and prevents collisions with persons or objects in time. Furthermore, a control 35, which controls the travel motions and other functions of the distributing vehicle 9 and parts thereof, is present at a suitable site.

At least one manipulator 10, which performs the handling tasks with the components 4, 5 and/or the component carriers 24, 25, is present on the distributing vehicle 9 at a suitable site. The manipulator 10 has a plurality of axes and may be arranged stationarily or detachably. It is preferably arranged in an elevated position on a base 41. The manipulator 10 is designed, e.g., as a multiaxial articulated-arm robot and has, for example, six rotatory axes. The manipulator 10 may have any desired number and type of rotary and/or translatory axes. It is likewise connected to the control 35. A suitable driven element, e.g., a multiaxial robot hand 39, which carries an optionally changeable tool 40, is arranged at its power take-off-side robot arm 38. The tool 40 is, for example, a one- or two-armed pallet gripper, with which one or more component carriers 24 can be grasped and moved multiaxially.

The distributing vehicle 9 shown in FIGS. 3 through 5 is designed as an individual car 51, which has one or more supports 30 for component carriers 24, 25, besides the manipulator 10. These component carriers 24, 25 may be positioned in a manner favorable for access, e.g., in the form of stairs. The supports 30 and the component carriers 24, 25 may have a modular dimension, which makes it possible to arrange component carriers 24, 25 of different types and sizes on one support 30 to increase the flexibility of transportation. A quick change possibility may be given as well. The supports 30 may be, e.g., frames with fixing elements for temporarily holding the component supports 24, 25. Furthermore, it is possible that one or more supports 30 are designed as racks, drawers or the like for being accommodated in the vehicle body in a surrounded or recessed manner. For example, drawers may be arranged here for small parts. The supports 30 lie in the work area 31 of the manipulator 10 and their arrangement is preferably optimized for maximum conveying capacity.

The distributing vehicle 9 has an outside and preferably peripheral protective enclosure 29, which denies people access to the interior space of the vehicle and to the supports 30 as well as to the manipulator 10. The protective enclosure 29 may be designed as a lattice fence or as a massive wall and integrate the front and rear walls of the distributing vehicle 9, which are present anyway. Separately secured accesses (not shown) may be present for maintenance purposes.

At least one docking means 32, which can optionally be extended laterally and cooperates with the stationary docking site, is arranged at the chassis 26 or at another suitable site. An energy coupling, which automatically docks with the energy supply 23, may be integrated in the docking means. For example, the higher energy demand necessary for the handling tasks of the manipulator 10 at the stop or docking site 22 can be supplied via this energy supply. The energy supply carried on board the vehicle can be limited as a result and designed for the travel operation. Control signals can also be exchanged in the above-described manner via the energy coupling. Furthermore, the distributing vehicle 9 may have a suitable means securing against tilting (not shown), which ensures stability during the motions of the manipulator and lifting operations. The means securing against tilting, which is equipped, e.g., with support pads or support struts, is activated or extended in the parked position or docked position and can cooperate with the docking site 22 and a support means present there.

The docking means 32 may have, furthermore, a position sensor system 33. The docking means 32 has, e.g., a floatingly mounted docking element for this purpose, which meshes with an opposing element at the docking site 22 in a positive-locking manner. The clearance of motion is at least as great as the positioning accuracy of the distributing vehicle 9 and compensates these tolerances. The preferably movably driven docking element is positioned at the opposite element with a search function and self-centering and meshed in a positive-locking manner. The path traveled now between a starting position and the actual docking position is measured with the position sensor system 33 and is sent into the control 35 as a correction value for the manipulator position. The position in space of the distributing vehicle 9 is detected from the known position in space of the docking site 22 and communicated to the control 35. The exact position in space of the manipulator 10 can be determined from this. As an alternative, the position sensor system 33 may also be associated with the docking site 22 and the kinematics can be correspondingly reversed.

As is illustrated in FIG. 5, the work area 31 of the manipulator 10 may be restricted. This can be brought about, e.g., by means of a mechanical or control technical locking means 34, which is in connection with the control 35 or optionally with the docking means 32. The docking means 32, arranged, for example, on both broad sides of the distributing vehicle 9, signals the working side directed towards the machining station 2 in case of docking and restricts it to the interior space of the distributing vehicle 9. Motion of the manipulator 10 beyond the opposite free side of the vehicle and the protective enclosure 29 located there is prevented by means of the locking means 34. Thus, workers 12 or other persons cannot enter the work area 31 of the manipulator 10 from this side. The locking and the function are correspondingly turned around if the distributing vehicle 9 is docked on the other side of the vehicle.

FIG. 10 shows a variant of the embodiment of the one-part distributing vehicle 9 shown in FIGS. 3 through 5. The right-hand side of FIG. 10 shows a distributing vehicle 9, which has a multipart design in the form of a train of cars and comprises a manipulator car 52 and one or more transport cars 53 coupled therewith. The manipulator 10 is located on the manipulator car 52, and there are only a few or no supports 30 for component carriers 24, 25. These supports 30 are arranged on the transport car or transport cars 53, which are located in the work area of the correspondingly designed manipulator 10. The transport car 53 can be uncoupled when needed, so that the manipulator car 52 can move in an isolated manner.

The distributing vehicle 9 and/or the manipulator 10 have a means 36 for clearing the protective enclosure 13 of the machining station 2. In the simplest case, this means 36 may be the manipulator 10, whose mobility and range of motion are designed and arranged such that it can grasp into the machining station 2 beyond the protective enclosure 13. It is favorable for this if the manipulator 10 is arranged in an elevated position on the base 41. In case of a corresponding design of the manipulator, the base 41 may, however, also be eliminated. The manipulator 10 can grasp with its tool 40 one or more component carriers 24 at the support 30, lift it/them over the protective enclosure 13 and deposit it/them within the machining plant 2 at a suitable site and in a predetermined position. Conversely, completely or partially emptied component containers 24 can be removed from the machining plant 2 and deposited on the supports 30. One or more holders 18 for component carriers 24, 25 are provided at predetermined sites within the machining station 2. Since no attention needs to be paid to ergonomic requirements due to the mechanical handling, the component carriers 24 can be deposited in the machining station 2 in positions favorable for the handling systems, e.g., elevated on stands 19. Due to the short handling times of the logistic manipulator 10, it is possible to change the component carriers 24 within the process time in the machining station 2, so that storage sites for component carriers 24 may be eliminated or substantially reduced within the station.

The holders 18 may have any desired and suitable design. They are preferably adapted to the shape of the component carriers 24, 25 and have suitable guide and fixing means. In the simplest means they are support plates with positioning pins. As an alternative, one or more holders 18 may also be designed as bulk material containers 20, into which small parts, e.g., screws, straps, etc., are introduced with their component carriers 24. As an alternative, the component carrier 24 filled with the small parts can be emptied by the manipulator 10 into the bulk material container 20. A separating means and feed for the further processing of the individual parts and for keeping them ready may be present at the bulk material container 20, e.g., a vibrating pot.

FIG. 10 shows a variant with heavyweight component carriers 25 and an access 15 to the machine in the protective enclosure 13. The component carrier 25 can be carried by the distributing vehicle 9 in a suitable manner or kept ready in another manner in the vicinity of the access 15 to the machine. The component carrier 25 rolls on rollers of its own or on other support means. A component carrier 25, whose weight or size exceeds the load or the handling capacity of the manipulator 10, can be pulled by the manipulator 10 over an oblique plane onto a corresponding support at the distributing vehicle 9, locked, and, conversely pushed off for unloading. The support may be arranged in a bay of the protective screen 29 or have a closable access in the protective screen 29. In another variant, the heavyweight component carrier 25 may be suspended on the distributing vehicle 9 and roll on wheels of its own during transportation.

The manipulator 10 pushes the component carrier 25 at the machining station 2 into the access 15 to the machine located preferably in a bay of the protective enclosure 13. The distributing vehicle 9 positioned directly in front of the access 15 to the machine screens out the access against persons.

The means 36 for clearing the protective enclosure 13 may comprise in this case an opening means 37, which is carried and activated by the manipulator 10 or the distributing vehicle 9. It contains a kind of key, with which the access 15 to the machine can be opened and its safety means 16 can be switched off. The manipulator 10 pushes the component carrier 25 in the above-mentioned manner to its intended place in the machining station 2 and possibly to a floor-side holder 18 and removes, possibly as an exchange, an empty component carrier 25. These exchange operations may, however, also take place separately at different times and on different occasions. After the end of the feeding and handling operations, the access 15 to the machine is again closed with the opening means 37.

FIG. 10 illustrates another variant with the readiness position and feed of components 4, 5. For example, a bay 17 is arranged in the protective enclosure 13, which bay accommodates one or more component carriers 24. On these component carriers, a worker 12 commissions one or more and optionally different components 4, 5, which he takes from a component magazine 42 located outside the traffic space 21. The worker 12 leaves after finishing, and the manipulator 10 of a distributing vehicle 9, which has been brought in, subsequently picks up the component carrier or component carriers 24 and moves them into the machining station 2 in a suitable manner over or through the protective enclosure 13. In this variant, the component carriers 24 can be in an ergonomically suitable position for manual mounting and commissioning and can be subsequently brought by the manipulator 10 into another position suitable for handling in the machining station 2.

The manipulator 10 knows the positions of the individual holders 18 in the machining station 2, e.g., from a teaching operation or by offline programming and can approach and service them directly. The corresponding data are stored in the control 35.

Each distributing vehicle 9 receives the request signals for feeding components 4, 5 and component carriers 24, 25 from one or more logistic controls 11 in the machining plant 1. These may be connected or integrated into the plant control or plant controls. The filling level of the component carriers 24, 25 is monitored within the machining station as needed, so that a request signal is sent to the logistic control 11 in time before they are emptied, the logistic control ensuring that the component or components 4, 5 needed is/are correspondingly available in time at the readiness position 6 and that these components 4, 5 are hauled off and fed with one or more distributing vehicles 9. The logistic control 11 also controls the travel motions of the distributing vehicles 9 and optionally the entire vehicle traffic. The sensor signals may be transmitted in any desired and suitable manner via line connections or in a wireless manner by radio, infrared light or the like.

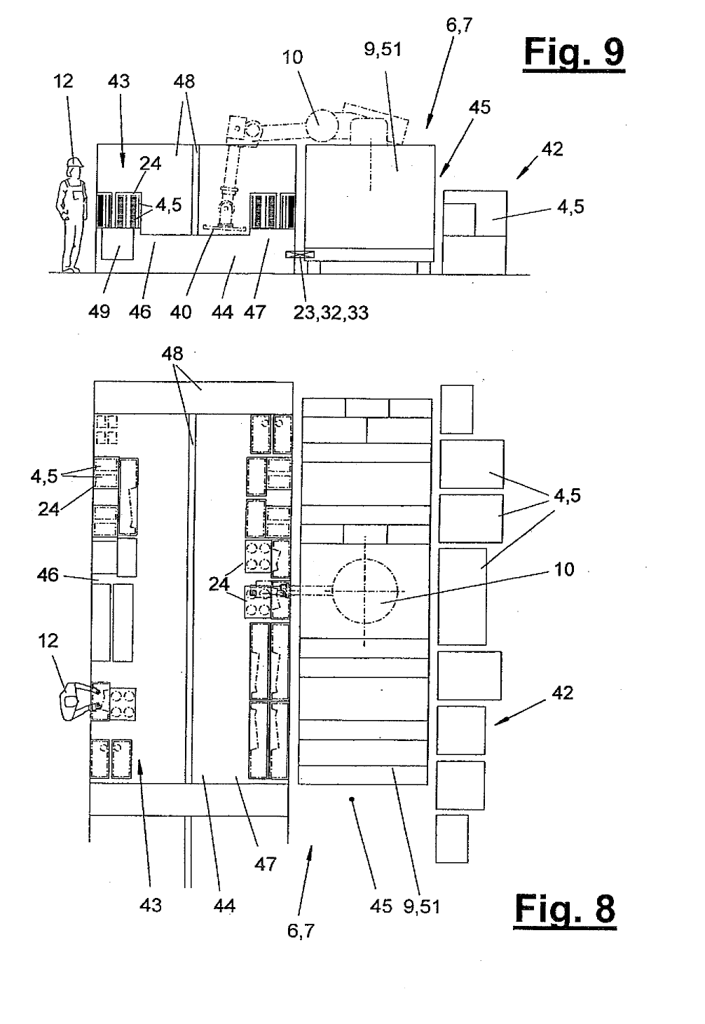

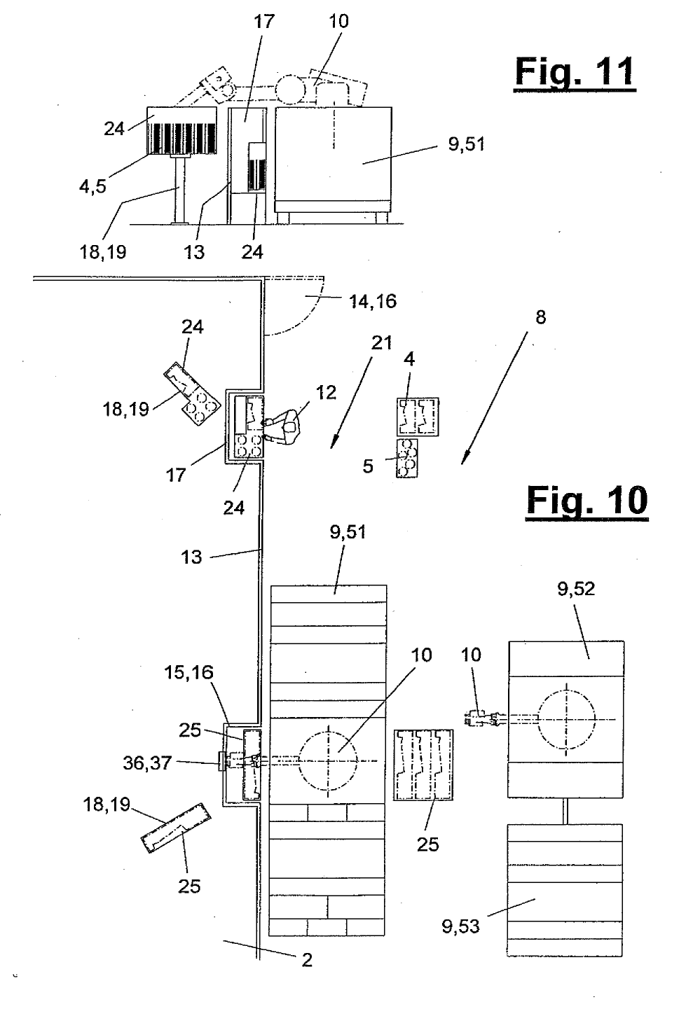

In a cut-away view, FIGS. 8 and 9 illustrate a component center 7, which is shown in a larger outline in FIG. 1. The component center 7 has one or more commissioning areas 43 with component magazines 42 for the manual or automatic commissioning and loading of component carriers 24, 25 with components 4, 5. A readiness table 44 with one or more associated component magazines 42, which are separated from the readiness table 44 by an aisle 45, is located at the individual commissioning area. The dimensions of the aisle in terms of length and width are preferably coordinated with the dimensions of a distributing vehicle 9. The aisle 45 is constructed such that workers 12 can walk on it and one or more distributing vehicles 9 can travel on it. One or more component carriers 24, 25 made ready with components 4, 5 from the component magazines 42 in the desired type, number and arrangement are loaded and commissioned at the readiness table 44. The component carriers 24, 25 may be optionally positioned at predetermined sites. The component carriers 24, 25 can be subsequently hauled off at this site by one or more distributing vehicles 9 and brought to the machining stations 2.

The readiness table 44 may have a plurality of, e.g., two table sides 46, 47, which are divided from each other by the protective enclosure 48. Manual commissioning operations and mechanical loading and unloading operations carried out by a logistic manipulator 10 can take place as a result simultaneously on the sides 46, 47 of the table. The protective enclosure 48 extends, e.g., in the longitudinal central axis of the readiness table 44 and on the transverse sides of the table areas 46, 47. Each side 46, 47 of the table has the aisle 45 and the component magazine 42 associated with it.

The readiness table 44 may have at the loading areas one or more lifting means 49, which can be actuated manually or automatically and are optionally driven by a motor, for raising or lowering the work surface and the component carriers 24, 25 locally or in an area larger than the table itself. These make possible, e.g., an ergonomically favorable low loading height and the formation of component stacks in the component carriers 24, 25 or of component carrier stacks. A higher position of the component carriers 24, 25 is kinematically more favorable for the logistic manipulator 10 for the loading and unloading operations.

Furthermore, one or more, essentially horizontally operating displacing means not shown, with which the work surface on the readiness table [sic-Tr.Ed.] 44 and/or the component magazines 42 can be displaced laterally in the longitudinal or transverse direction, may be arranged in the commissioning area 43. It is possible, as a result, e.g., to reduce the width of the aisle in order to improve ergonomics and to shorten the paths for the worker 12 during the commissioning and loading of the component carriers 24, 25. In addition, one or more loading aids not shown, which may have, e.g., a crane-like design and support and relieve the worker 12 during the component 4, 5 loading and conveying operations, may be present in the component center 7.

The safety of persons within the component center 7 is guaranteed by the protective enclosures 48. The safety sensor system 28 or another suitable means ensures that a distributing vehicle 9 can enter an aisle 45 only when no worker 12 is located there. On the other hand, by adapting the width of the distributing vehicle 9 and the aisle 45, access for workers 12 into this area of the aisle is prevented.

The readiness position 6, especially in the embodiment as a component center 7, has a control 50, which communicates with the logistic control 11 in a suitable manner. The worker 12 thus receives information in time on the type and number of components 4, 5 requested by one or more machining stations 2. How and where he has to make these components 4, 5 ready at the readiness table 44 in the component carriers 24, 25 may optionally also be signaled to him optically, acoustically or in another manner. These readiness positions are likewise preferably preset and known to the manipulator 10 for grasping securely. In addition, the component magazines 42 may have a means for monitoring the filling level, which is likewise connected to the control 50. The fact that the components are running low can thus be signaled and the components 4, 5, delivered in large packages, can be requested on time. This reorder may be carried out fully automatically via the control 50 or by manual intervention on the part of the worker 12.

It is, furthermore, possible in a fully automatic variant that the manipulator 10 of the distributing vehicle 9 itself organizes and performs the commissioning and loading. To do so, it can grasp the individual components 4, 5 from the component magazine 42, with a suitable, possibly changed tool 40, and load its component carriers 24, 25, which it carries with it on the supports 30. The manipulator 10 also carries out the unloading of the empty component carriers 24, 25 automatically in the component center 7 or at another readiness position 6.

Just as at the machining stations 2, one or more stationary docking sites 22 with the above-described embodiments and functions, including energy supply and position determination, can be arranged at the readiness position 6 or the component center 7. Furthermore, the control 50 of the component center 7 can also communicate with the controls 35 of the distributing vehicles 9. The controls 35 of the distributing vehicle 9 can in turn also be connected to the station and plant controls.

The control and steering of the distributing vehicle or distributing vehicles 9 may take place in any desired and suitable manner. It may be a radio control, a floor-side inductive vehicle guiding or the like. The manipulators 10 are controlled, e.g., via a programmable continuous-path control, in which the positions of the supports 30 and of the component carriers 24, 25 on the distributing vehicle 9 as well as on the readiness table 44 as well as the positions of the holders 18 in the machining stations 2 are stored as absolute positions or relative to the docking sites 22, whose position is likewise known. Such docking sites 22 may also be present in the readiness position 6, especially the component center 7.

The manipulator 10 may be equipped with a changing device for changing its tools 40. This enables it to perform other tasks. These may be, on the one hand, the aforementioned tools for joining and processing the components 4, 5 during the conveying thereof on the distributing vehicle 9. On the other hand, these tools may be [intended] for participating in the processes taking place within the station. The manipulator 10 can be used, furthermore, for maintenance, inspection or cleaning work within the machining stations 2. The tools may be designed for this as spray guns, grease guns, industrial vacuum units or the like. Due to the fact that the width of the station can be reduced thanks to the component logistics according to the present invention, the manipulator 10 can extend relatively far into the machining station 2 and automatically clean and lubricate, e.g., chains there or inspect trailing cables or critical machine components for damage with a camera or video system. Another possibility of use is the automatic emptying of chip containers at cutting mills.

The logistic system is used for feeding components 4, 5 to machining stations 2 in the exemplary embodiment being described. The use may also be reversed, in which case components are removed in connection with disassembly lines.

The manipulator 10 may be equipped with a camera or video system for detecting and analyzing images in the above-described manner. This can also be used for logistic purposes, e.g., for checking the filling level of the component magazines 42 or of the component carriers 24, 25 located in the machining stations 2, which is to be performed by the manipulator 10. In addition, the manipulator 10 may be guided and positioned by means of this camera system.

The features of the above-described exemplary embodiments may be interchanged and combined with one another as desired. Furthermore, various variants of the design and functional embodiments described are possible. This pertains, e.g., to the arrangement of the control, the assignment of stations 2 and readiness positions 6, the number, design and motion of the distributing vehicles 9. It is possible, in particular, to have distributing vehicles 9 of different types and sizes within one machining plant 1. Furthermore, commissioning of components 4, 5 and loading of component carriers 24, 25 in the machining plant 1 may be completely or partially eliminated. Components 4, 5 may be precommissioned, e.g., at the manufacturer and delivered already in component carriers 24, 25 or in another form of packaging suitable for the logistics described and made available at the readiness position 6.

While specific embodiments of the invention have been shown and described in detail to illustrate the application of the principles of the invention, it will be understood that the invention may be embodied otherwise without departing from such principles.

### LIST OF REFERENCE NUMBERS

1 Machining plant
2 Machining station
3 Workpiece, body part
4 Component
5 Component
6 Readiness position for components
7 Component center
8 Component feeding means
9 Distributing vehicle
10 Manipulator
11 Control, logistic control
12 Worker
13 Protective enclosure, fence
14 Access, access for persons
15 Access, access to machine
16 Safety means
17 Bay
18 Holder for component carrier
19 Stand
20 Bulk material container
21 Traffic space
22 Docking site
23 Energy supply
24 Component carrier, container, pallet
25 Component carrier, roller pallet
26 Chassis
27 Driver stand
28 Safety sensor system
29 Protective screen
30 Support for component carrier
31 Work area
32 Docking means, energy coupling
33 Position sensor system
34 Locking means for work area
35 Control
36 Means for clearing the protective enclosure
37 Opening means
38 Robot arm
39 Robot hand
40 Tool, pallet gripper
41 Base
42 Component magazine
43 Commissioning area
44 Readiness table
45 Aisle
46 Table side
47 Table side
48 Protective enclosure
49 Lifting means
50 Control
51 Individual car
52 Manipulator car
53 Transport car

1. A machining plant comprising:
a machining station with a protective enclosure surrounding same;
a readiness position; and
a feeding means for feeding components feeding means comprising distributing vehicle movable between said readiness position and said machining station, said distributing vehicle having a multiaxial manipulator, with a means for clearing said protective enclosure and with a support for component carriers.

2. A machining plant in accordance with claim 1, wherein free traffic spaces and a docking site for said distributing vehicle are arranged on an outside at said protective enclosure of said machining station.

3. A machining plant in accordance with claim 1, further comprising a holder for said component carriers arranged in said machining station within said protective enclosure.

4. A machining plant in accordance with claim 1, further comprising a holder for said component carriers arranged in a work area of said manipulator.

5. A machining plant in accordance with claim 1, wherein said manipulator is arranged in an elevated position on a base.

6. A machining plant in accordance with claim 1, wherein said distributing vehicle has an opening means for providing access in said protective enclosure.

7. A machining plant in accordance with claim 1, wherein said protective enclosure comprise a fence.

8. A machining plant in accordance with claim 1, wherein said protective enclosure bays on the outside for receiving one or more of said component carriers.

9. A machining plant in accordance with claim 1, wherein said component carrier picks up a plurality of components of the same kind in a precommissioned arrangement for automatic access.

10. A machining plant in accordance with claim 1, wherein said component carrier is designed as a container or as a pallet.

11. A machining plant in accordance with claim 1, wherein said component carrier is designed as a roller pallet.

12. A machining plant in accordance with claim 1, wherein said manipulator is designed as an articulated-arm robot and has a tool for handling said component carriers.

13. A machining plant in accordance with claim 1, wherein said distributing vehicle can be steered manually or by remote control.

14. A machining plant in accordance with claim 1, wherein said distributing vehicle is designed as a individual car for the combined conveying of the manipulator and components or as a train of cars with at least one said manipulator car for said components.

15. A machining plant in accordance with claim 1, wherein said distributing vehicle has a chassis with a protective screen surrounding on the outside.

16. A machining plant in accordance with claim 1, wherein said supports have a support grid for different said component carriers.

17. A machining plant in accordance with claim 1, wherein said distributing vehicle has a docking means, cooperating with a docking site.

18. A machining plant in accordance with claim 17, wherein said docking means is movable and has a position sensor system.

19. A machining plant in accordance with claim 1, wherein said distributing vehicle has a control for said manipulator with a docking-dependent locking means for said working area of said manipulator.

20. A machining plant in accordance with claim 1, wherein said readiness position is designed as a component center and has a commissioning area with component magazines for the manual or automatic commissioning and loading of said component carriers with components.

21. A machining plant in accordance with claim 20, wherein a readiness table with a component magazine arranged at a spaced location by an aisle is arranged at said commissioning area.

22. A machining plant in accordance with claim 1, wherein said readiness table has a plurality of table sides divided by a protective enclosure with an associated aisle and a component magazine.

23. A machining plant in accordance with claim 22, wherein the width and length of said aisle are adapted to the dimensions of the vehicle and said aisle is closed when said distributing vehicle has entered.

24. A machining plant in accordance with claim 1, wherein said readiness table has a lifting means.

25. A machining plant in accordance with claim 1, wherein said distributing vehicle has a safety sensor system for the protection of persons.

26. A machining plant in accordance with claim 1, further comprising a control providing logistics of said components and of said distributing vehicles.

27. A machining plant in accordance with claim 26, wherein said control includes control units connected by a data telecommunication.
